(19) United States
(12) Patent Application Publication
(10) Pub. No.: US 2003/0063622 A1
(43) Pub. Date: Apr. 3, 2003

(54) Transport of in-band signaling with reduced overhead on digital subscriber line transceivers

(76) Inventor: Carl Christian Hansen, Aloha, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/967,047

(22) Filed: Sep. 28, 2001

(51) Int. Cl. H04L 12/66

(52) U.S. Cl. 370/463; 375/222

(57) ABSTRACT

Within the United States, telephony signaling is transported in-band to the telephony voice sample by “robbing” single bit locations within the stream. When transporting such digital signals transparently over digital subscriber line (DSL) channels, the signaling bits require the 64 kbit/sec channel be open while no call is connected in order to signal the line state. Described herein is a framer and a technique that allows a reduced number of bits to pass through the DSL link while in the on-hook condition in order to signal the line state without wasting DSL bandwidth.

### FIELD

The invention relates to Digital Subscriber Line (DSL) communications. More specifically, the invention relates to techniques for transporting in-band signaling with reduced overhead using DSL transceivers.

### BACKGROUND

Typical telephone lines transmit data at a rate of 64 kbit/sec, which is sufficient to provide high quality voice communications. These same lines are used to transmit data from computer systems or other electronic devices at rates up to 56 kbit/sec. Additional bandwidth can be provided by aggregating multiple channels between network nodes. This bandwidth can be provided according to multiple strategies including dynamically allotting channels as requested by a network node.

In current Digital Subscriber Line (DSL) architectures, a single voice call may be transmitted digitally using a 64 kbit/sec channel in the DSL data stream. A 64 kbit/sec channel is consumed by a telephone whether or not the phone is in use. This is because signaling bits are required to signal the state of the line. When a telephone is in use, or “off the hook,” one or more bits in the data stream can be “robbed” and used to signal the state of the line. However, when the telephone is not in use, or “on the hook,” these signaling bits are still required to signal the state of the line. Current DSL architectures use the full 64 kbit/sec for state of line signaling. However, because 64 kbit/sec is not required to signal the state of the line, current DSL architectures are inefficient. In general, only 8 kbit/sec is required to support state of line signaling. Therefore, 56 kbit/sec may be consumed, but unused when a telephone is on the hook and data transfer is occurring.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of a system for providing voice and data support via digital subscriber lines.

FIG. 2a illustrates a DSL data stream carrying interleaved voice signals and data signals where the 64 kbits/sec used by the voice channel is fixed .

FIG. 2b illustrates a data stream carrying interleaved voice signals and data signals is variable based on bandwidth provided to the voice signals.

FIG. 3a illustrates one embodiment of components for transmitting a data stream carrying interleaved voice signals and data signals is variable based on bandwidth provided to the voice signals.

FIG. 3b illustrates one embodiment of components for receiving a data stream carrying interleaved voice signals and data signals is variable based on bandwidth provided to the voice signals.

### DETAILED DESCRIPTION

Techniques for transporting in-band signaling with reduced overhead using DSL transceivers are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Within the United States, telephony signaling is transported in-band to the telephony voice sample by “robbing” single bit locations within the stream. When transporting such digital signals transparently over digital subscriber line (DSL) channels, the signaling bits require the 64 kbit/sec channel be open while no call is connected in order to signal the line state. Described herein is a framer and a technique that allows a reduced number of bits to pass through the DSL link while in the on-hook condition in order to signal the line state without wasting DSL bandwidth.

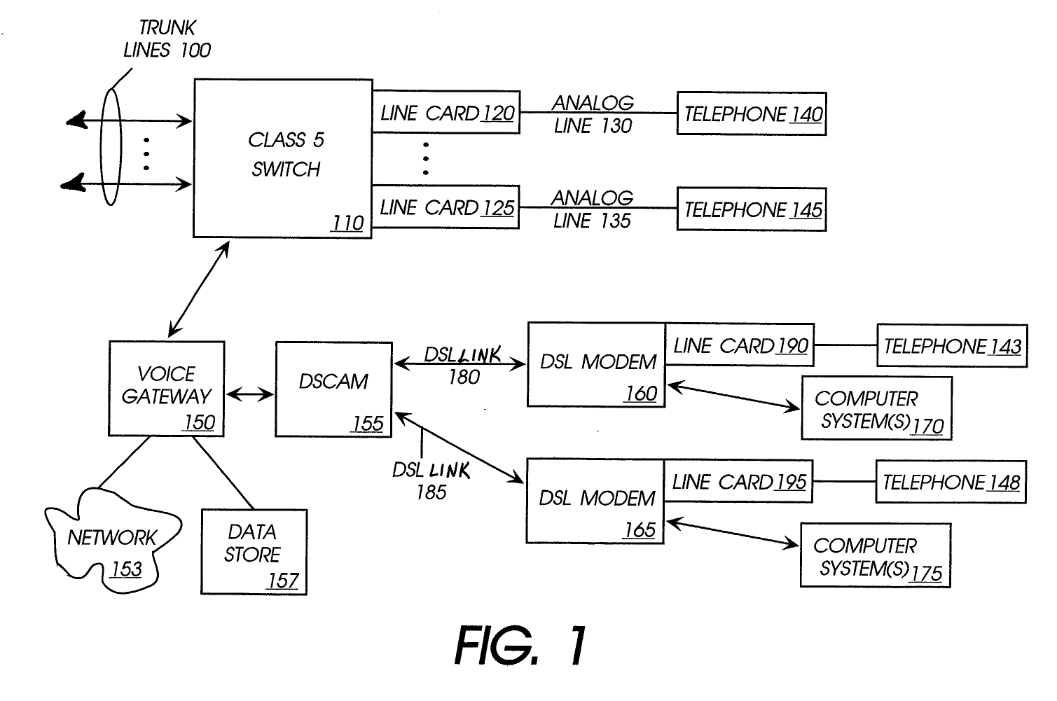

FIG. 1 is a block diagram of one embodiment of a system for providing voice and data support via digital subscriber lines. Telecommunications carriers transmit signals over trunk lines 100, which can be, for example, T1 lines, T3 lines, or any other type of transmission medium known in the art. Trunk lines 100 carry signals between class 5 switch 110 and other switches (not shown in FIG. 1). Class 5 switches provide switching between trunk lines 110 and line cards, for example, line cards 120 and 125 and other devices, for example, voice gateway 150.

Line cards 120 and 125 provide an interface between class 5 switch 110 and analog lines 130 and 135, respectively. Analog lines 130 and 135 are traditional telephone lines (e.g., twisted pair), which are known in the art. Analog lines 130 and 135 connect telephones 140 and 145 to line cards 120 and 125, respectively. The interconnection of class 5 switch 110, lines cards 120 and 125, analog lines 130 and 135, and telephones 140 and 145 represent traditional telephone communication using SS-7 signaling.

Common Channel Signaling System No. 7 (SS-7) is a global standard for telecommunications defined by the International Telecommunications Union (ITU-T) recommendation Q.700 to define procedures and protocols by which network elements of public switched telephone networks (PSTNs) exchange information to provide call setup, routing and control.

Class 5 switch 110 is coupled to voice gateway 150. In one embodiment, voice gateway 150 includes framer circuits (not shown in FIG. 1) that allow the DSL data streams to carry interleaved voice signals and data signals where the interleaving is variable. Voice gateway 150 can optionally be coupled to network 153 and/or data store 157, for example, to receive instructions or for control purposes.

Voice gateway 150 is coupled to digital subscriber line access multiplexor (DSLAM) 155. DSLAM 155 separates the voice frequency signals from high-speed data traffic and controls and routes DSL traffic between end user equipment (e.g., router, modem, network interface card) and voice gateway 150. DSLAM 155 receives signals from voice gateway 150 and routes them to the appropriate subscriber location via DSL links (e.g., 180, 185). Similarly, DSLAM 155 receives signals via DSL links and routes the signals to voice gateway 150.

In general, class 5 switch 110, voice gateway 130 and DSLAM 155 are typically located in a central office controlled by a service provider. Analog lines 130 and 135 and DSL links 180 and 185 allow communication between the service provider and various subscribers. Typically, DSL subscribers must be within a predetermined physical radius from the central office while analog subscribers can be located at any physical distance from the central office.

DSL links 180 and 185 provide a communications path between the service provider central office and subscriber locations. Subscribers have one or more DSL modems that provide an interface between DSL links and the individual devices that communicate via the DSL links. FIG. 1 illustrates two DSL modems; however, any number of DSL modems can be coupled to a DSLAM.

DSL modem 160 is coupled to DSL link 180 and includes line card 190. Line card 190 provides an analog telephone interface between DSL modem 160 and telephone 143. Computer system(s) 170 is/are coupled to DSL modem 160, which provides a data path between one or more computer systems and DSLAM 155. Similarly, DSL modem 165 is coupled to DSL link 185 and includes line card 195, which provides an interface between DSL modem 165 and telephone 148. Computer system(s) 175 is/are coupled to DSL modem 165, which provides a data path between one or more computer systems and DSLAM 155.

In one embodiment, when telephone 148 is off the hook, or in use, DSL modem 165 allots telephone 148 a 64 kbit/sec channels for communications purposes. The 64 kbit/sec channel is used for voice communication as well as state of line signaling in an any manner known in the art. DSL modem 165 allots the remaining available bandwidth to computer system(s) 175.

When telephone 148 is on the hook, or not in use, DSL modem 165 allots telephone 148 less than 64 kbits/sec for state of line signaling purposes. In one embodiment, DSL modem 165 allots telephone 148 eight kbits/sec for state of line signaling purposes; however, the bandwidth used for state of line signaling purposes can be less than or greater than eight kbits/sec. DSL modem 160 can operate in a manner similar to that of DSL modem 165.

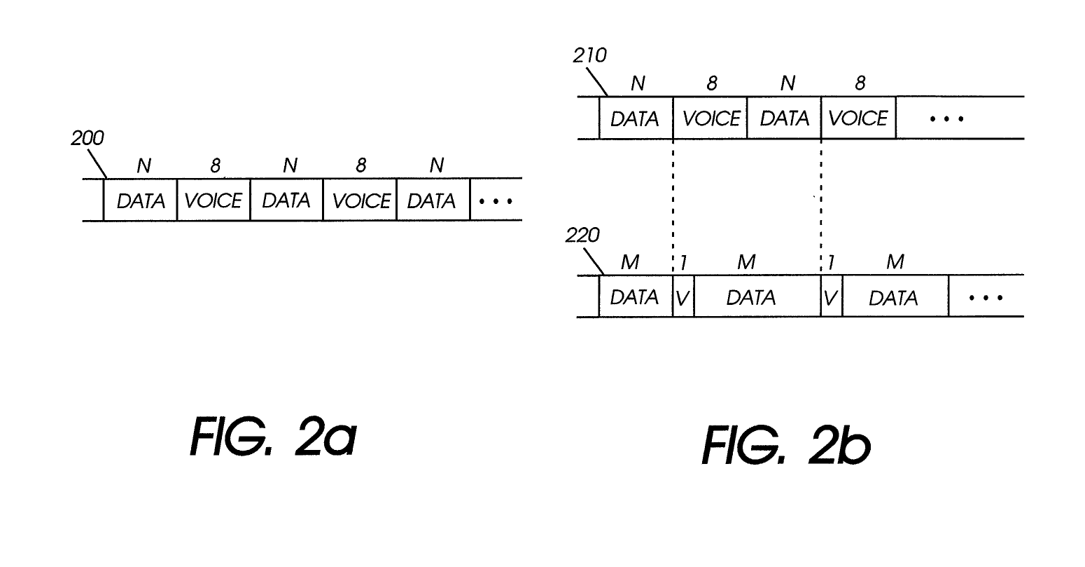

FIG. 2a illustrates a data stream carrying interleaved voice signals and data signals is fixed. Data stream 300 as illustrated in FIG. 2a includes N bits of data information interleaved with 8 bits of voice information. The specific value of N is dependent upon the total bandwidth provided by a DSL link and can be fixed or variable. The 8-bit blocks of voice information are transmitted at a frequency of 8 kHz to provide a 64 kbit/sec channel to carry a telephone connection. In an alternate embodiment, voice signals can be communicated using channels providing different bandwidth.

FIG. 2b illustrates two data streams one for an on-hook condition and one for an off-hook condition. Data stream 210 is similar to data stream 200 of FIG. 2a in that a 64 kbit/sec voice channel is provided. The 64 kbit/sec is used for voice signaling when the telephone is in the off-hook condition. Data stream 210 supports interleaved voice and data signaling.

Data stream 220 is used when the telephone is in the on-hook condition. In one embodiment, data stream 220 includes a one-bit 8 kHz, or 8 kbit/sec, signal to support state of line signaling when the telephone is in the on-hook condition. In alternate embodiments, a different bandwidth (e.g., 16 kbit/sec) could be used during on-hook conditions. The 8 kbit/sec channel is used to perform signaling operations such as, for example, ringing, busy signals, etc.

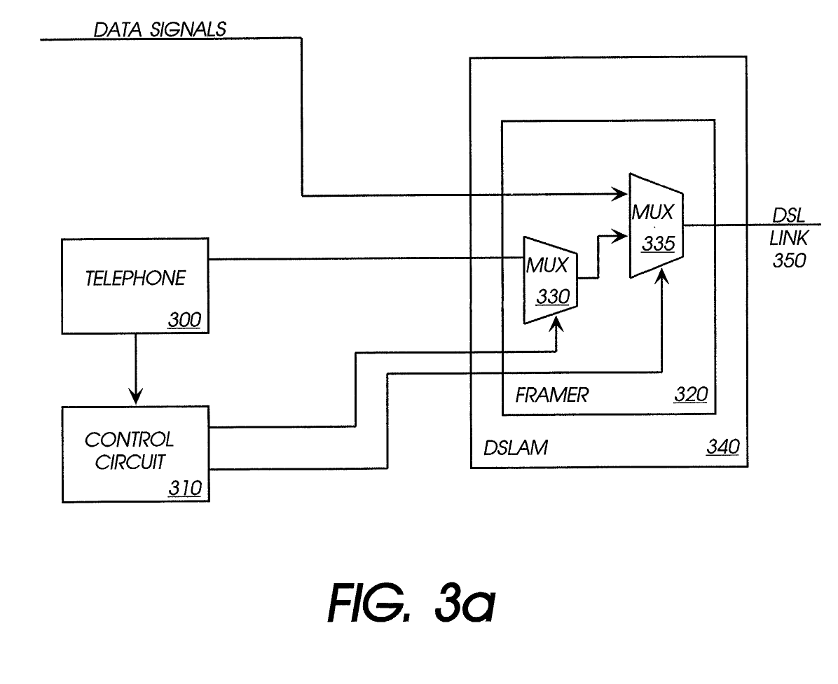

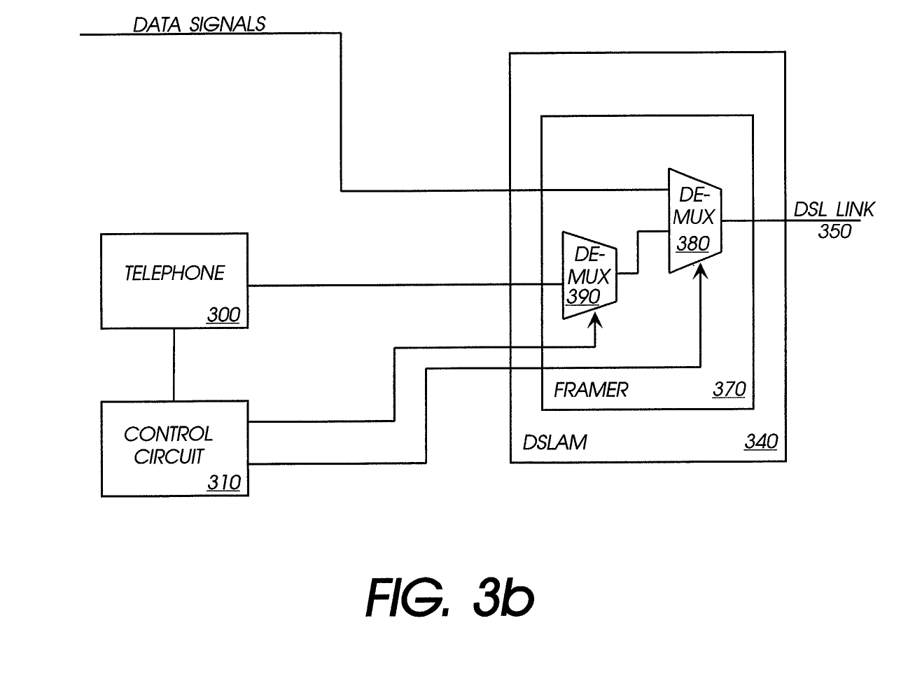

FIG. 3a illustrates one embodiment of components for transmitting a data stream carrying interleaved voice signals and data signals is variable based on bandwidth provided to the voice signals. Telephone 300 is coupled to framer 320. In one embodiment, framer 320 is a part of DLAM 340, which includes other components not illustrated in FIG. 3a. In alternate embodiments, framer 320 can be separate from or independent of DSLAM 340.

Telephone 300 is coupled to control circuit 310 to communicate whether telephone 300 is in the on-hook or off-hook condition. Control circuit 310 sends control signals to multiplexor 330 and multiplexor 335 to select the signals that are to be passed to DSL link 350. In one embodiment, multiplexor 330 receives an 8-bit signal from telephone 300 (via an analog to digital converter, not shown). The 8-bit signal can be transmitted in a parallel or in a serial manner. Multiplexor 330 selects between passing the full 8-bit voice signal and passing a 1-bit signal for state of line signaling.

Multiplexor 335 receives the output of multiplexor 330 and data signals from other sources, for example, computer systems. When multiplexor 330 is passing a 1-bit signal, multiplexor 335 can pass additional bits of data signal to provide additional bandwidth to devices (not shown in FIG. 3a) other than telephone 300. Thus, when multiplexor 330 is passing only line state signals from telephone, the 56 kbit/sec of bandwidth that otherwise would have been unused is filled with data from devices other than telephone 300.

FIG. 3b illustrates one embodiment of components for receiving a data stream carrying interleaved voice signals and data signals is variable based on bandwidth provided to the voice signals. Telephone 300 is coupled to framer 370. In one embodiment, framer 370 is a part of DLAM 340, which includes other components not illustrated in FIG. 3b. In alternate embodiments, framer 370 can be separate from or independent of DSLAM 340.

Control circuit 310 sends control signals to demultiplexor 380 and demultiplexor 390 to select the signals that are to be passed from DSL link 350. In one embodiment, demultiplexor 380 passes an 8-bit signal to telephone 300 (via a digital to analog converter, not shown) when telephone 300 is in the off-hook condition. Demultiplexor 390 selects between passing the full 8-bit voice signal and passing a 1-bit signal for state of line signaling.

The framer circuits are described in terms of operation on the subscriber side of DSL links. However, corresponding framer circuits are also coupled to the provider side of the DSL links. The provider side framers route state of line signaling bits and voice signal bits to the appropriate devices on the service provider side. In one embodiment, a control circuit on the provider side of the DSL link snoops the state of line signals to determined whether the associated telephone is in the on-hook or off-hook condition.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

### APPENDIX A

William E. Alford, Reg. No. 37,764 ; Farzad E. Amini, Reg. No. 42,261; William Thomas Babbitt, Reg. No. 393,591; Carol F. Barry, Reg. No. 41,600; Jordan Michael Becker, Reg No. 39,602; Lisa N. Benado, Reg. No. 39,995; Bradley J. Bereznak Reg. No. 33,474; Michael A. Bernadicou, Reg. No. 35,934; Roger W. Blakely, Jr., Re;. No. 25,831; R. Alan Burnett Reg. No. 46,149; Gregory D. Caldwell, Reg No. 39,926; Andrew C. Chen, Reg. No. 43,544; Thomas M. Coaster, Reg. No. 39,637; Donna Jo Coningsby, Reg. No. 41,684; Florin Corie, Reg. No, 46,244; Dennis M. DeGuzman Reg. No. 41,702; Stephen M. De Klerk, Reg. No. P46,503; Michael Anthony DeSanctis, Reg. No. 39,957; Daniel M. De Vos, Reg. No. 37,813; Justin M. Dillon, Reg. No. 42,486; Sanjeet Dutta, Reg. No. P46,145; Matthew C. Fagan, Reg. No. 37,542; Tarek N. Fahami, Reg No. 41,402; Mark W. Farrell Reg. No. 45,998; George Fountain Reg. No. 37,374; James Y. Go, Reg. No. 40,621; James A. Henry Reg. No. 41,064 , Wilmore F. Holbrow No. P41,845; Sheryl Sue Holloway, Reg. No. 37,850; George W. Hoover II, Reg. No. 32,992; Eric S. Hyman Reg. No. 30,139; William W. Kidd, Reg. No. 31,772; Sang Hui Kim, Reg No. 40,450; Walter T. Kim, Reg. No. 42,731; Eric T. King, Reg. No. 44,188; George B. Leavell, Reg. No. 45,436; Kurt P. Leyendecker, Reg. No. 42,799; Gordon R. Lindeen III, Reg No. 33,192; Jan Carol Little, Reg. No. 41,181; Robert G. Litts, Reg. No. 46,876; Julio Loza Reg, No. 47,758; Joseph Lutz Reg. No. 43,765; Michael J. Mallio, Reg. No. 36,591; Andre L. Marais, under 37 C.F.R §10.9(b); Paul A. Mendonan Reg. No. 42,879; Clive D. Menezes, Reg. No. 45,493; Chun M. Ng, Reg. No. 36,878; Thien T, Nguyen, Reg. No. 43,835; Thinh V. Nguyen, Reg, No. 42,034; Dennis A. Nichols, Reg. No. 42,036; Daniel E. Ovanezian, Reg. No. 41,236; Kenneth D. Paley, Reg. No. 38,989; Gregg A. Peacock, Reg. No. 45,001; Maria Porthova, Reg. No. P45,750; Michael A. Proksch, Reg. No. 43,021; William F. Ryann, Reg. 44,313; James H. Salter, Reg. No. 35,668; William W. Schall, Reg. No. 39,018; James C. Scheller, Reg. No. 31,195; Jeffery S. Schubert Reg. No. 43,098; George Simion, Reg. No. P47,089; Maria McCormack Sobrino, Reg. No. 31,639; Stanley W. Sokoloff, Reg. No. 25,128; Edwin H. Taylor, Reg, No. 25,129; Lance A. Temes, Reg. No.43,184; John F. Travis, Reg. No. 43,203; Joseph A. Twarowski, Reg. No, 42,191; Kerry D. Tweet Reg. No. 45,959; Mark C. Van Ness, Reg. No. 39,865; Thomas A. Van Zandt, Reg. No. 43,219; Lester J. Vincent, Reg. No. 31,460; Glenn E. Von Tersch, Reg. No. 41,364 ; Jobn Patrick Ward, Reg, No. 40,216; Mark L. Watson, Reg No. P46,322; Thomas C. Webster, Reg. No. P46,154; and Norman Zafman, Reg. No. 26,250; my patent attorneys, and Firasat Ali, Reg. No. 45,715; Richard Nakashima, Reg. No. 42,023; my patent agents of BLAKLEY, SOKOLOFF, TAYLOR & ZAFMAN LLP, with offices located at 12400 Wilshire Boulevard, 7th Floor, Los Angeles, Calif. 90025, telephone (310) 207-3800, and Alan K. Aldous, Reg. No. 31,905; Ben Burge, Reg, No. 42,372; Robert A. Burtzlaff Reg. No. 35,466; Richard C. Calderwood, Reg. No. 35,468; Jeffrey S. Draeger, Reg. No. 41,000; Cynthia Thomas Faatz, Reg. No. 39,973; Jeffrey B. Huter, Reg. No. 41,086; John Kacvinsky, Reg. No. 40,040; Seth Z. Kalson, Reg. No. 40,670; David J Kaplan, Reg. No. 41,105; Peter Lam, 44,855; Anthony M. Martinez, No. 44,23; Paul Nagy, Reg No. 37,896; Leo V. Novakoski, Reg. No. 37,198; Thomas C. Reynolds, Reg. No. 32,488; Kenneth M. Seddon, Reg. No. 43,105; Mark Seeley, Reg. No. 32,299; Steven P. Skabrat Reg, No. 36,279; Howard A. Skaist, Reg. No. 36,008; Robert G. Winkle, Reg. No. 37,474; Sharon Wong, Reg. No. 37,760; Steven D. Yates, Reg. No.42,242; Calvin B. Wells, Reg. No.43256 and Charles K. Young, Reg. No.39,435; my patent attorneys, and my patent agents, of INTEL CORPORATION; and and James R. Thein, Reg. No. 31,710, may patent attorney; with full power of substitution and revocation, to prosecute this application and to transact all business in a Patent and Trademark Office connected herewith.

What is claimed is:

1. A method comprising:
transmitting a communication stream with a first proportion of voice signals to data signals when a telephone coupled to receive the communication stream is in a first state, wherein the voice signal includes both audio and control signals; and
transmitting the communication stream with a second proportion of voice signals to data signals when the telephone is in a second state, wherein the voice signal includes control signals and no audio signals.

2. The method of claim 1 wherein the communication stream is transmitted according to a digital subscriber line (DSL) protocol.

3. The method of claim 2 wherein the DSL protocol comprises asynchronous DSL (ADSL).

4. The method of claim 1 wherein the first proportion comprises an 8-bit voice signal transmitted at 8 kHz and the second proportion comprises a 1-bit voice signal transmitted at 8 kHz.

5. The method of claim 1 further comprising:
receiving a second communication stream with the first proportion of voice signals to data signals when the telephone is in the first state; and
receiving the second communication stream with the second proportion of voice signals to data signals when the telephone is in the second state.

6. An article comprising a medium accessible by one or more electronic devices, the medium to provide content that, when accessed by the one or more electronic devices, cause the one or more electronic devices to:
transmit a communication stream with a first proportion of voice signals to data signals when a telephone coupled to receive the communication stream is in a first state, wherein the voice signal comprises both sampled audio and control signals; and
transmit the communication stream with a second proportion of voice signals to data signals when the telephone is in a second state, wherein the voice signal includes control signals and no audio signals.

7. The article of claim 6 wherein the communication stream is transmitted according to a digital subscriber line (DSL) protocol.

8. The article of claim 7 wherein the DSL protocol comprises asynchronous DSL.

9. The article of claim 6 wherein the first proportion comprises an 8-bit voice signal transmitted at 8 kHz and the second proportion comprises a 1-bit voice signal transmitted at 8 kHz.

10. The article of claim 6 further comprising content that, when accessed by the one or more electronic devices, cause the one or more electronic devices to:
receive a second communication stream with the first proportion of voice signals to data signals when the telephone is in the first state; and
receive the second communication stream with the second proportion of voice signals to data signals when the telephone is in the second state.

11. A propagated signal that carries content to one or more electronic devices, the propagated signal comprising a communication stream with a first proportion of voice signals to data signals when a telephone coupled to receive the communication stream is in a first state, wherein the voice signal comprises both sampled audio and control signals and the communication having a second proportion of voice signals to data signals when the telephone is in a second state, wherein the voice signal includes control signals and no audio signals.

12. The propagated signal of claim 11 wherein the communication stream is transmitted according to a digital subscriber line (DSL) protocol.

13. The propagated signal of claim 12 wherein the DSL protocol comprises asynchronous DSL.

14. The propagated signal of claim 11 wherein the first proportion comprises an 8-bit voice signal transmitted at 8 kHz and the second proportion comprises a 1-bit voice signal transmitted at 8 kHz.

15. The propagated signal of claim 11 further comprising content that, when accessed by the one or more electronic devices, cause the one or more electronic devices to:
receive a second communication stream with the first proportion of voice signals to data signals when the telephone is in the first state; and
receive the second communication stream with the second proportion of voice signals to data signals when the telephone is in the second state.

16. An apparatus comprising:
a control circuit coupled to a telephone to determine whether the telephone is in a first state or in a second state, the control signal to generate one or more control signals to indicate the state of the telephone;
a framer coupled to the control circuit and to the telephone, the framer to allot a first bandwidth for telephone communication when the telephone is in the first state and to allot a second bandwidth for telephone communication when the telephone is in the second state.

17. The apparatus of claim 16 wherein the first bandwidth comprises 8 kbit/sec and the second bandwidth comprises 64 kbit/sec.

18. The apparatus of claim 16 wherein the first state is an on-hook state and the second state is an off-hook state.

19. The apparatus of claim 16 wherein the framer further comprises:
a first multiplexor to receive signals from the telephone, the first multiplexor to pass the fill signals from the telephone when the telephone is in the second state and to pass reduced signals when the telephone is in the first state; and
a second multiplexor coupled to receive signals passed by the first multiplexor, the second multiplexor to pass the signals from the first multiplexor and to pass additional data signals, the additional data signals consuming a first bandwidth when the telephone is in the first state and a second bandwidth when the telephone is in the second state.

20. An apparatus comprising:
a control circuit coupled to a telephone to determine whether the telephone is in a first state or in a second state, the control signal to generate one or more control signals to indicate the state of the telephone; and
a framer to receive signals from a digital subscriber line (DSL) link, the framer to allot a first bandwidth to the telephone when the telephone is in the first state and to allot a second bandwidth to the telephone when the telephone is in the second state.

21. The apparatus of claim 20 wherein the first bandwidth comprises 8 kbits/sec and the second bandwidth comprises 64 kbits/sec.

22. The apparatus of claim 20 wherein the first state is an on-hook state and the second state is an off-hook state.

23. The apparatus of claim 20 wherein the framer further comprises:
a first demultiplexor to pass signals from the DSL link, the signals from the DSL link including data signals and voice signals, the data signals consuming a first bandwidth when the telephone is in the first state and a second bandwidth when the telephone is in the second state; and
a second demultiplexor coupled to receive signals passed by the first demultiplexor, the second demultiplexor to pass the signals from the first demultiplexor and to pass the full signals to the telephone when the telephone is in the second state and to pass reduced signals when the telephone is in the first state.

24. A framer comprising circuitry to pass signals between a digital subscriber line (DSL) link, a telephone and one or more data processing devices, the signals including data signals and voice signals, the framer to allot a first bandwidth to a telephone coupled to the framer when the telephone is in an off-hook condition and the framer to allot a second bandwidth to the telephone when the telephone is in an on-hook condition.

25. The framer of claim 24 wherein the first bandwidth is greater than the second bandwidth.

26. The framer of claim 24 wherein the first bandwidth comprises 64 kbit/sec.

27. The framer of claim 26 wherein the second bandwidth comprises 8 kbit/sec.

28. The framer of claim 24 further comprising:
a first multiplexor to pass a complete voice channel when the telephone is in the off-hook condition and to pass less than the complete voice channel when the telephone is in the on-hook condition;
a second multiplexor coupled to receive an output of the first multiplexor, the second multiplexor to pass variable amounts of data signal based on the condition of the telephone;
a first demultiplexor to pass variable amounts of data signal based on the condition of the telephone; and
a second demultiplexor coupled to receive an output of the first demultiplexor, the second demultiplexor to pass a complete voice channel when the telephone is in the off-book condition and to pass less than the complete voice channel when the telephone is in the on-hook condition.
